(19) United States
(12) Patent Application Publication
(10) Pub. No.: US 2007/0221302 A1
(43) Pub. Date: Sep. 27, 2007

(54) Cover for an air-conditioner unit

(76) Inventor: Terry Boone, Winthrop Harbor, IL (US)

Correspondence Address: GEORGE LAWRENCE BOLLER, SUITE 316, 17199 N LAUREL PARK DR, LIVONIA, MI, 48152, US

(21) Appl. No.: 11/726,126

(22) Filed: Mar. 21, 2007

Related U.S. Application Data
(60) Provisional application No. 60/785,082, filed on Mar. 23, 2006.

(51) Int. Cl. B65D 85/00; B65D 65/02; E05C 21/02

(52) U.S. Cl. 150/165; 206/320; 49/465

(57) ABSTRACT

A cover (30) for covering the interior face of a through-the-wall air-conditioner unit. The cover is constructed from three pieces of sheet material (34, 36, 38) to form a front wall, a bottom wall, and two side walls and provide a continuous perimeter margin having a hem (52) containing an elastic shock cord (50) that elongates to a stretched condition to allow the cover to fit over the air-conditioner unit and exert a holding force for holding the cover in place.

### REFERENCE TO A RELATED APPLICATION AND PRIORITY CLAIM

This application claims the priority of Provisional Application No. 60/785,082, filed on 23 Mar. 2006.

### FIELD OF THE INVENTION

This invention relates to a cover for covering the interior of an air-conditioner unit, especially a through-the-wall air-conditioner unit.

### BACKGROUND OF THE INVENTION

A through-the-wall air-conditioner unit is one that mounts in an opening in a wall of a building, such as a home, hotel, motel, apartment, townhouse, office, etc. The opening extends from the exterior of the wall to an interior space within the building.

To provide for more convenient installation of the air-conditioner unit, and service and/or replacement of the unit when needed, a metal sleeve that is open at both ends lines the wall opening. Because the typical air-conditioner unit has a rectangular shape, the sleeve has an open rectangular transverse cross section just slightly larger than that of the unit, allowing the unit to be slid into and out of the sleeve, typically through the end that opens to the building interior. The outside perimeter of the sleeve is typically sealed to the wall opening in any suitably appropriate way.

The interior end of the air-conditioner unit contains controls and the interior air circuit. Interior room air is drawn through an air inlet and passes across an evaporator where it is cooled. It is then blown back into the interior.

A condenser is located at the exterior end of the unit where it is open to the outside air through the open exterior end of the sleeve. The refrigeration circuit comprises a compressor that sucks refrigerant through the evaporator and forces it into the condenser where heat is rejected to the outside air.

During non-air-conditioning seasons, it may be desirable to cover the exterior end of the unit, particularly for functional reasons. If the clearance between the unit and the sleeve is not fully sealed, winds or drafts may pass through between exterior and interior, occasioning heat loss from the interior. Hence, covering the exterior can reduced heat loss due to less than perfect sealing between the unit and the sleeve.

It may also be desirable to cover the interior of such a unit, and an interior cover may be used alone or in conjunction with an exterior cover.

Covers are sometimes homemade without a great deal of concern for their exterior appearance. Homemade covers may look unattractive and be constructed less than perfectly in which case they may not fully block all air leaks. In a building that has multiple dwelling or office units each equipped with one or more through-the-wall air-conditioner units, such as an apartment or office building, individual tenants who do not cover their units may experience drafts and heat loss.

An interior cover should be attractive to the occupants.

Various forms of covers for air-conditioner units are disclosed in the following U.S. Pat. Nos.: 4,019,556; 4,308,905; 4,325,229; 4,332,114; 4,625,784; 4,745,769; 4,788,805; 5,125,197; 5,307,849; 6,397,617; and 6,430,954. A novel cover for the exterior of an air-conditioner unit is the subject of a pending patent application of the inventor, application Ser. No. 10/924,013.

### SUMMARY OF THE INVENTION

It is believed that an air-conditioner cover that can provide improved appearance and essentially complete blocking of drafts, and that can be easily installed and removed, would represent a meaningful improvement. The present invention relates to a new and improved cover for an air-conditioner unit that possesses these attributes. Although the cover is especially adapted for covering the interior of certain through-the-wall air-conditioner units, it could be used to cover any window unit having an interior end like that of a through-the-wall unit for which the cover can presently be used, if such window units were to be manufactured.

### BRIEF DESCRIPTION OF THE DRAWINGS

FIG. 1 is a perspective view of a through-the-wall air-conditioner unit as viewed from the interior of a building such as an apartment or office.

FIG. 2 is a view similar to FIG. 1 but with the inventive cover in place covering the interior of the air-conditioner unit.

FIG. 3 is a plan view of a part of the inventive cover by itself.

FIG. 4 is in a plan view of another part of the inventive cover by itself.

FIG. 5 is an enlarged fragmentary view of a portion of the margin of the completed cover to show the shock cord.

FIG. 6 is a perspective view of a portion of the interior of the cover to show stitching.

FIG. 7 is a cross section view in the direction of arrows 7-7 in FIG. 5.

### DETAILED DESCRIPTION OF THE INVENTION

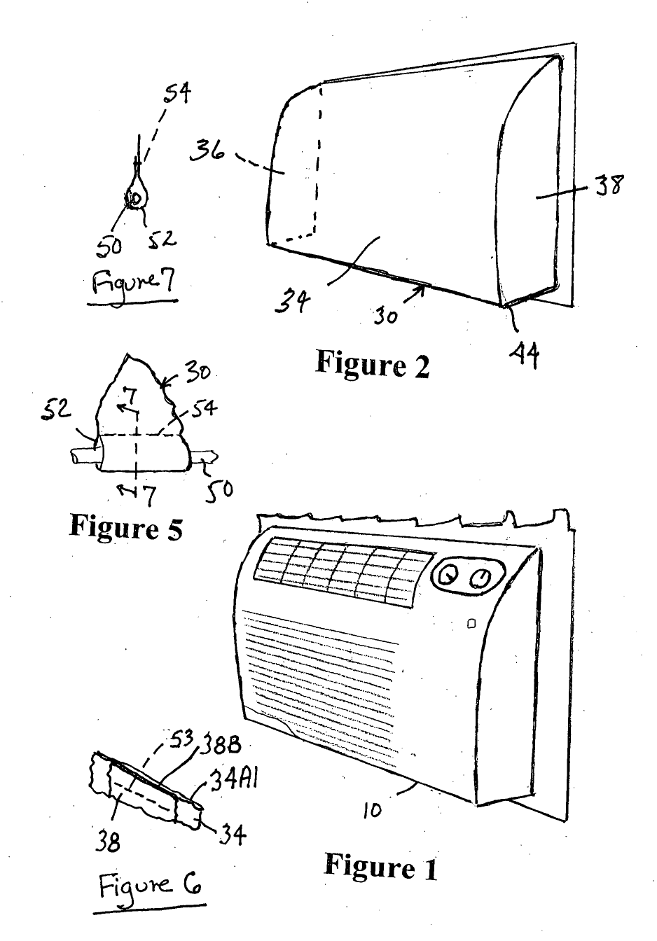

FIG. 1 shows the interior of a through-the-wall air-conditioner unit 10.

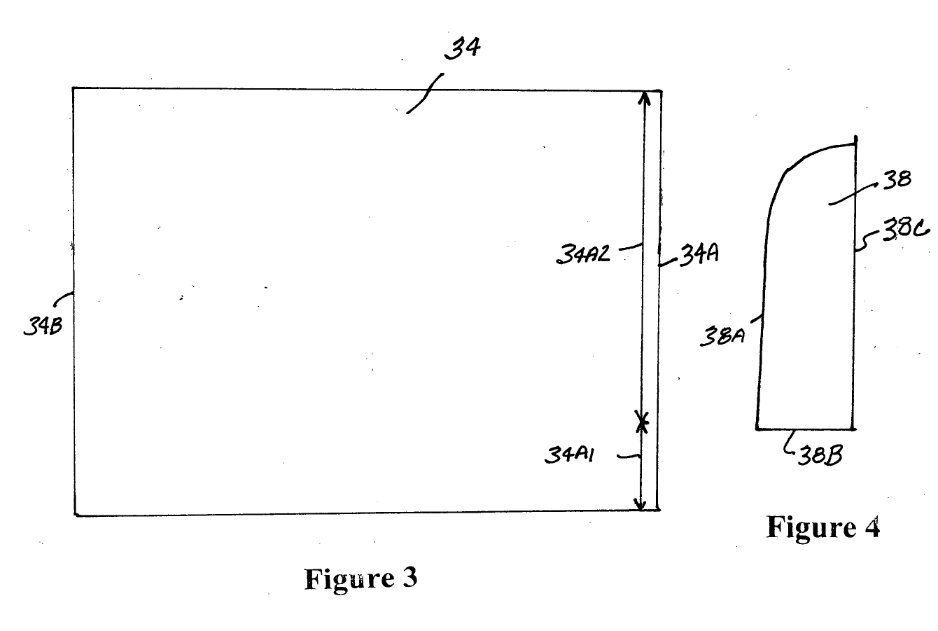

FIG. 2 shows a cover 30 embodying principles of the invention covering the interior of unit 10. In a preferred embodiment, cover 30 is fabricated from three sheets of material 34, 36, 38 that are stitched together. Sheet 34 is shown in FIG. 3, and sheet 38 is shown in FIG. 4, both with their exterior faces facing the reader. Sheet 36 is the mirror image of sheet 38.

Sheet 38 has edges 38A, 38B, and 38C. Sheet 34 is essentially rectangular and is wider than it is high. A shorter edge of sheet 34 is identified by the reference numeral 34A.

Extending from a front end of edge 38B, edge 38A is initially generally straight but tapers along a convex curvature as it approaches edge 38C.

The sum of the lengths of edges 38B and 38A is approximately the same as the length of edge 34A. Edge 34A may be considered to comprise two segments 34A1 and 34A2. The margin of sheet 38 running along edge 38B and the margin of sheet 34 running along edge segment 34A1 are placed together substantially congruently, exterior face against exterior face, and when so placed they are then stitched together along a line of stitching 53 slightly inward of each edge as shown by the fragmentary view of FIG. 6. The stitching is done from what will become the interior of the cover when the cover is placed on the air-conditioner unit so that the stitching is not exposed to view when the cover is placed on the unit. The margin running along edge 38A and that running along edge segment 34A2 are placed together substantially congruently, exterior face against exterior face, and the stitching is continued along a line of stitching slightly inward of each edge, with the stitching still being done from what will become the interior of the cover when the cover is placed on the air-conditioner unit. This creates a distinct corner 44 shown in FIG. 2. It also imparts a convex curvature to the upper portion of sheet 34 that follows the convex curvature of the upper portion of edge 38A.

Sheet 36 is associated with and stitched to the margin of the opposite edge 34B of sheet 34 in the same way. The result of stitching the three sheets together in this way creates a continuous free edge.

Thereafter the margin of that free edge is folded over an elastic shock cord 50 (FIG. 5) that has been placed on the interior face of the cover and the folded-over margin is stitched to the cover to create a hem 52 that encloses the elastic shock cord. When the cord is not being stretched, it has a length less than the nominal length of the hem, causing the hem to contract in length due to gathering and puckering of the sheet material. When cover 30 is to be installed, the hem unpuckers to elongate from contracted condition with the stretching of the cord. The nominal perimeter length of the hem when the hem is not gathered and puckered is slightly greater than the perimeter of the air-conditioner unit against which the open end of the cover fits. The stitching 54 that secures the folded-over margin to the cover can be seen on the exterior of the cover as shown in FIG. 7.

Because the cord is not being stretched during stitching of the hem, the material that forms the hem gathers along the portion of the length of the hem that has been stitched so that stitching is conducted between flat portions of the zones being stitched. After the stitching has been completed, the material in the hem has gathered and puckered.

In the completed cover, the free edge margin perimeter length is contracted from what it was prior to creation of the hem because the cord is not being stretched. When the cord is stretched to allow the cover to be installed, the hem ungathers, causing the open end of the cover to enlarge and expand the perimeter length of the free edge margin for fitting the cover over and onto the air-conditioner unit. When the cover is in place, the tension created by the stretching of the cord forces the hem against the perimeter of the air-conditioner unit, proving a forceful surface-to-surface contact of the perimeter margin to the unit.

From the description that has been given, the reader can appreciate that the cover comprises a front wall formed by the portion of sheet 34 that is contiguous with edge portion 34A2, a bottom wall formed by the portion of sheet 34 that is contiguous with edge portion 34A1, and two side walls formed by sheets 36, 38. When the cover is installed, the front wall curves in the downward direction first convexly and then generally straightly to meet with the bottom wall along a generally horizontal line from which the bottom wall extends generally horizontally inward to a generally horizontal bottom margin of the cover vertically below and generally parallel with the top margin of the cover. Each side wall has a first margin that curves in the downward direction initially convexly and then generally straightly to join with a respective side margin of the front wall, a second margin that joins with a respective side margin of the bottom wall, and a third margin that forms a respective generally vertical margin of the cover between the top and bottom margins of the cover. The horizontal top and bottom margins of the cover and the vertical side margins of the cover form a continuous perimeter margin that is folded over an elastic cord and stitched to the cover to form a hem containing the elastic cord for holding the margin of the cover on an air-conditioner unit when the cover is covering the interior face of the air-conditioner unit.

The cover can be easily installed and removed without the use of tools. It provides effective blocking of air leaks when in use, and it can be folded for storage when removed. It can also provide some degree of protection for the unit against dust and dirt. A desirable material for cover 30 is fleece-lined vinyl. The vinyl provides the material forming the exterior faces of the sheets, and the fleece, the material for interior. The shock cord is an endless loop of elastic material that can expand and contract in length.

The vinyl is available in different colors affording a choice of colors. Because of the inventive principles, the inventor has been able to fit a large variety of through-the wall units using only a limited number of cover sizes. As can be appreciated, that is a significant competitive advantage.

While a presently preferred embodiment of the invention has been illustrated and described, it should be appreciated that principles of the invention apply to all embodiments falling within the scope of the following claims.

What is claimed is:

1. A cover that when in place covering an interior face of an air-conditioner unit comprises:
a front wall, two side walls, and a bottom wall, the front wall extending downward from a generally horizontal top portion of a continuous perimeter margin of the cover by curving in the downward direction initially convexly and then generally straightly to meet with the bottom wall along a generally horizontal line from which the bottom wall extends generally horizontally inward to a generally horizontal bottom portion of the continuous perimeter margin of the cover that is vertically below and generally parallel with the top portion of the continuous perimeter margin of the cover, each side wall having a first margin that curves in the downward direction initially convexly and then generally straightly to join with a respective side margin of the front wall, a second margin that joins with a respective side margin of the bottom wall, and a third margin that forms a respective generally vertical portion of the continuous perimeter margin of the cover between the top and bottom portions, the continuous perimeter margin comprising a hem containing an elastic cord for holding the continuous perimeter margin on an air-conditioner unit when the cover is covering the interior face of the air-conditioner unit.

2. A cover as set forth in claim 1 wherein each wall comprises a fleece-lined synthetic material arranged such that the synthetic material forms an exterior face of the cover, and fleece lining forms an interior face.

3. A cover as set forth in claim 2 wherein the synthetic material comprises vinyl.

4. A cover as set forth in claim 1 wherein the sheet of material is essentially non-stretchable and is gathered and puckered along the length of the elastic cord when the elastic cord is not elongated to stretched condition.

5. A cover as set forth in claim 1 wherein the front and bottom walls comprise a single piece of sheet material that is folded to demarcate the front wall from the bottom wall.

6. A cover as set forth in claim 5 wherein each side wall comprises a respective piece of sheet material that is joined to the sheet material containing the front and bottom walls by stitching.

7. A cover as set forth in claim 6 wherein the stitching is placed in abutted margins of edges of the pieces of sheet material so as to be concealed from view when the cover is in place on an air-conditioner unit.
